(19) United States
(12) Patent Application Publication
(10) Pub. No.: US 2002/0187788 A1
(43) Pub. Date: Dec. 12, 2002

(54) Mobile communications system

(76) Inventor: Charles Laurence McKay, Malden, MA (US)

Correspondence Address: NAREN CHAGANTI, ESQ, 524 KENDALL AVE, #5, PALO ALTO, CA, 94306, US

(21) Appl. No.: 10/165,804

(22) Filed: Jun. 7, 2002

Related U.S. Application Data
(60) Provisional application No. 60/296,974, filed on Jun. 7, 2001.
(60) Provisional application No. 60/318,543, filed on Sep. 8, 2001.
(60) Provisional application No. 60/345,914, filed on Oct. 24, 2001.

(51) Int. Cl. H04Q 7/20

(52) U.S. Cl. 455/450; 455/455

(57) ABSTRACT

In a mobile communications system, when traffic conditions deteriorate, a priority scheme allows predetermined types of calls to be differently serviced, so that higher priority subscribers obtain the maximum possible bandwidth or other resources. Conversely, when traffic conditions improve, additional bandwidth may be allocated to existing subscribers or additional subscribers/types of service may be permitted to maximize bandwidth utilization.

Further, when a mobile call disconnects, the disclosed system saves the context at which the call was disconnected and attempts to restore pre-disconnection status to the connection, if the subscriber wishes to reconnect within a prescribed time limit. In an embodiment, the instant disclosure preserves the call context by writing call-related data in a data store on network side or on mobile terminal side or on both sides. On the network side, call related in formation may be stored in a file, which can also identify the mobile terminal. On the mobile terminal side, the call related information is stored in the form of a cookie or other store and preserved in nonvolatile memory. By thus preserving the call information (context as well as other information) when the subscriber reestablishes connection with the mobile communication network within the prescribed time limit, the subscriber may be prompted to continue with his prior activity, and if he chooses so, he can be reconnected to perform the same task as before.

### TECHNICAL FIELD

The present invention is related in general to a mobile communications systems, and in particular, to a method and apparatus to handle dropped connections in a wireless communication system and for other services.

### BACKGROUND

Wireless communication systems, as opposed to wire-line systems, are more susceptible to disruptions in calls. There are several reasons for this. Solar activity, ion storms that generate massive electrical charges in the ionosphere, lightning bolts, and other similar atmospheric disturbances can cause a connection to break. Further, overloaded cell sites or radio interference from other radio systems operating in a close region may result in disruptions. Such disruptions frustrate customers and may result in an increased subscriber turnover, called churning. Wireless service providers, therefore, would like to reduce disruptions in their networks in order to maintain subscriber loyalty. Accordingly, there is a need for an improvement in the art.

### SUMMARY

The following description uses the word “subscriber” to mean any user of a mobile communication service. The subscriber may be an individual, a machine or a business. In an aspect, the disclosure herein is directed toward monitoring calls in a mobile communication network, and, based on what is detected, taking steps to optimize the utility of the network. For instance, the disclosure is directed toward monitoring calls for traffic conditions, disruptions, usage, subscriber-type and other conditions. The disclosure contemplates using Network agents and Software agents to monitor call conditions.

In another aspect, when traffic, atmospheric or other conditions deteriorate, a priority scheme disclosed herein allows predetermined types of calls to be differently serviced, so that higher priority subscribers obtain the maximum possible bandwidth or other resources. Conversely, when traffic conditions improve, additional bandwidth may be allocated to existing subscribers or additional subscribers/types of service may be permitted to maximize bandwidth utilization.

In a further aspect, when calls disconnect, the disclosed system saves the context at which the call was disconnected and attempts to restore pre-disconnection status to the connection, if the subscriber wishes to reconnect within a prescribed time limit. In an embodiment, the instant disclosure preserves the call context by writing call-related data in a data store on network side or on mobile terminal side or on both sides.

On the network side, call related in formation may be stored in a file, which can also identify the mobile terminal. On the mobile terminal side, the call-related information is stored in the form of a cookie or other store. Preferably the call-related information is preserved in nonvolatile memory. By thus preserving call information (context as well as other information) when the subscriber reestablishes connection with the mobile communication network within the prescribed time limit, the subscriber may be prompted to continue with his prior activity, and if he chooses so, he can be reconnected to perform the same task as before.

In a yet another aspect, the disclosed system is configured to distinguish different call types. A voice call that is disconnected may be reconnected within a predetermined time. A data call, where a subscriber downloads a large or a small chunk of data from a packet switched network, the subscriber call information may be handled in a different way. In one aspect, both calls are treated similarly, and the subscriber is provided a choice regarding reconnection either immediately or within a predetermined time after the disconnection. In the case of a data call, if the traffic, atmospheric or other conditions degrade and/or unstable to sustain a high-fidelity transmission of a very large chunk of data, for example, of a movie, then the disclosed system may provide the subscriber an option of downloading the data at a later time, preferably, after the network conditions get better. In that case, the system may download and cache the movie for later downloading by the subscriber to his mobile terminal device.

Alternative embodiments allow the subscriber to select time period before his disconnected call would not be reconnected, the amount of cache space provided to the subscriber on the network side, and other parameters, for which a service provider may charge a fee based on the nature and quality of resources that the subscriber selected.

### BRIEF DESCRIPTION OF THE DRAWINGS

These and other features, objects, and advantages may be more readily understood from the following detailed description with reference to the appended figures, wherein,

FIG. 1 (PRIOR ART) shows a typical mobile communication system;

FIG. 2 illustrates the complexity of signaling hierarchy in a system such as the GSM;

FIG. 3 shows BSCs connected to Base Transceiver Station (BTS), and other elements of the wireless network;

FIG. 4 shows the architecture of a Base Station Controller (BSC) that is used in a wireless communication system for a 3G wireless service;

FIG. 5 is a diagram showing the configuration of agent system operation in accordance with an embodiment; and

FIG. 6 is a flow chart depicting the steps performed in an illustrative embodiment.

### DETAILED DESCRIPTION

### Architecture of a Mobile Communications System

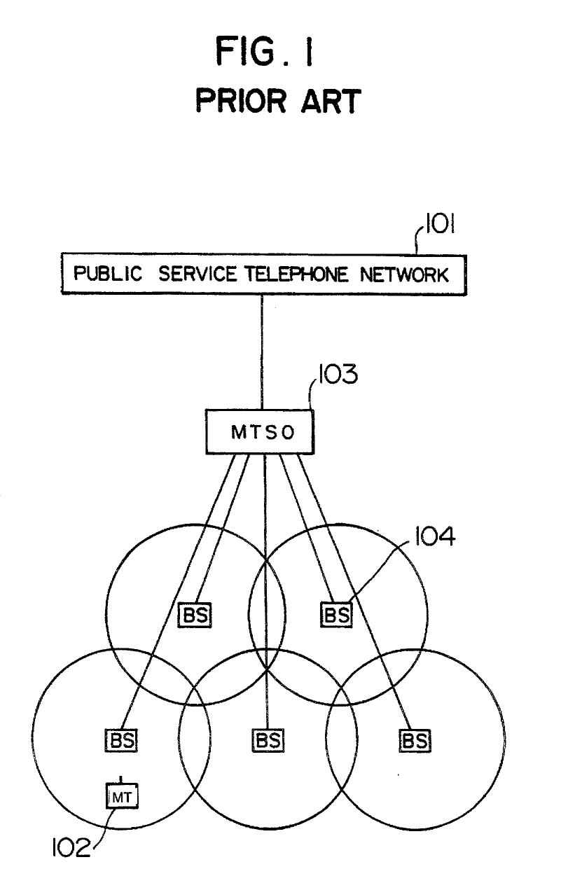

FIG. 1 (PRIOR ART) shows a typical mobile communication system. A terminating call from a public service telephone network (PSTN) 101 to a mobile terminal (MT) 102 once enters a mobile telephone switching office (MTSO) 103 and the MTSO 103 causes a base station controller (BS or BSC) 104 serving under the MTSO to call the MT 102 of interest. When this MT 102 responds, the MTSO 103 allots a radio channel between the MT 102 and the MBS 104 covering the cellular zone in which the MT 102 exists to establish a communication line. In the case of an originating call from the MT 102, the MTSO 103 similarly allots a radio channel between the MT 102 and the BSC 104. Typically, the BSC 104 has previously been assigned a predetermined number of radio channels and a channel for communication with the MT 102 is selected from unused radio channels in advance of communication with the MT 102.

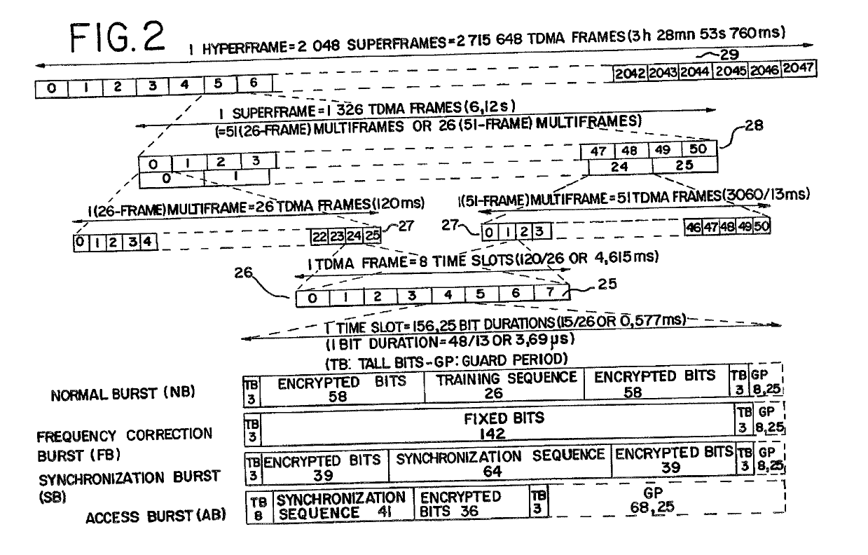

FIG. 2 illustrates the complexity of signaling hierarchy in a system such as the GSM, where a plurality of subscribers shares many services and functions. The GSM system uses time division multiple access (TDMA) techniques and the logical signaling channels are mapped into time slots 25. The signal within one time slot 25, which is used to transfer information to and from a mobile terminal 22, is called a burst. Eight time slots 25 make up one TDMA frame 26. Multiframes 27 are made up of a plurality of frames 26, e.g. either 26 or 21 depending upon the function of the slots 25 in the frames 26. Superframes 28 are made up of a plurality of Multiframes 27 and Hyperframes 29 are made up of Superframes 28.

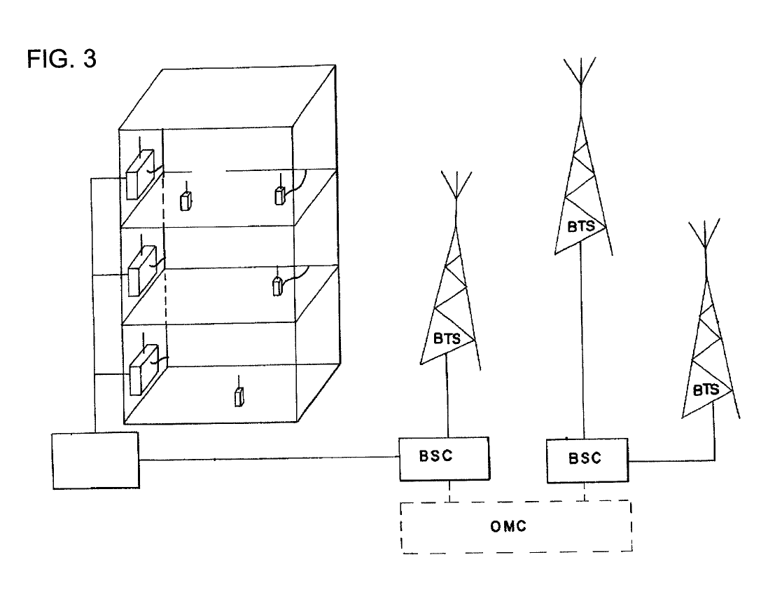

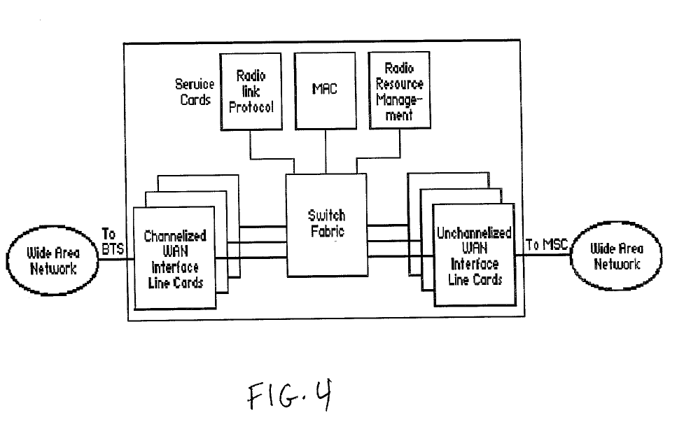

FIG. 3 shows BSCs connected to Base Transceiver Station (BTS), and other elements of the wireless network. Further, as is known from the European Global System for Mobile Communications (GSM) system, the BSC may be operatively coupled to an Operations and Maintenance Controller (OMC). Detailed descriptions of the GSM system may be found in the book “Mobile Radio Communications”, by Raymond Steele, Pentech Press, 1992 or “The GSM system for mobile communications”, by Michel Mouly and Marie-Bernadette Pautet, Cell & Sys, 1992 as well as in the relevant GSM ETSI standards themselves. It should be noted, however, that the inventive principles are not limited to the GSM or any particular standard; rather, the GSM is used to illustrate the principles.

Typically, a frequency band is allocated for transmission from the base stations to the mobile stations (the down-link band) and a different frequency band is allocated for transmission from the mobile stations to the base stations (the uplink band) but the present invention is not limited thereto. Each cell of a conventional cellular telephone system is allocated a number of frequencies for communication purposes selected from these two bands, i.e. each slot may be transmitted at one or more frequencies selected from the frequencies assigned to a particular cell. The frequencies assigned to one cell in a large system are usually not unique. A frequency reuse plan may be devised so that cells that use the same frequencies are spaced sufficiently far apart from each other that there is little or no interference. The frequency allocation and reuse plan is set up and executed by the OMC. This plan may be modified from time to time in order to accommodate system extensions or changes in traffic density. Such changes are carried out relatively infrequently, e.g. once a week, so that the network can rely on the frequency use in surrounding cells remaining constant for a considerable time, e.g. days, weeks or even months.

Typically, a BTS transmits a burst in every time slot in every single frame on one of the allocated frequencies, the so-called beacon frequency C0. The bursts may be either subscriber or system messages e.g., voice messages, data messages or control signals, or so-called dummy bursts, i.e. a special type of burst which is inserted when no other burst would be inserted. Even when frequency hopping is used within the system, no frequency hopping is used for the time slots on this beacon frequency C0.

In a densely crowded and highly used conventional cellular telephone system there is considerable radio signaling activity. When a mobile station is switched on, it must first identify signals coming from the various BTSs of the surrounding cellular system. Conventionally, the mobile stations operating with BTS scan for the so-called beacon frequencies C0 of the BTS in surrounding cells as these are transmitted continuously. Beacon frequencies C0 are also the frequencies at which common signaling messages are broadcast within the cells of a GSM system by the base transceiver stations. In order for the mobile station to identify that the continuous transmission at the beacon frequency C0 comes from a BTS and not from another source, particular bursts present in one or more of the slots transmitted at the beacon frequency C0 may be used for recognition purposes, e.g. frequency control bursts.

FIG. 4 shows the architecture of a Base Station Controller (BSC) that is used in a wireless communication system such as a Third-Generation (3G) Wireless communication system. A BSC contains a switching fabric, which is operationally coupled to a BTS on the one hand via channelized WAN Interface Line Cards, and to a Mobile Switching Center (MSC) on the other via unchannelized WAN Interface Line Cards. The switching fabric is coupled to service circuits to handle Radio Link Protocol (RLP), MAC layer and Radio Resource Management (RRM).

### Server Computer

A suitably programmed server computer may be used to illustrate the principles discovered herein. The server computer could be a general purpose computer and contains a central processor unit (CPU) such as Pentium IV® microprocessor, memory such as semiconductor memory, input device such as a keyboard or mouse, output device such as an LCD screen or a CRT, storage device such as hard disk and a communication device such as a network card. Of course, other necessary elements may include a power supply and supporting electronic circuits that are known to persons of ordinary skill in the art. An example of such a server computer is an IBM Netegrity™ server configured to connect to a private network such as a Local Area Network or a public network such as the World Wide Web. In turn, in an embodiment, the server computer is communicatively coupled to the BSC of a mobile communications network.

It is understood that in addition to hardware elements, the computers, mobile terminal devices and/or other devices described in this application may comprise software programs such as the Linux™ Operating System and other software code that enables a subscriber to program code that instructs the CPU to perform specified tasks. The program code may be written in a low level language such as an assembler language or in a high level language such as C, C++, or the Java programming language using methodologies such as object oriented programming, structured programming, agent-based programming, and other such methods. Persons of ordinary skill in the art know these things and a description of those details is unnecessary. It should be understood that there could be a single server performing all the tasks, or there could be a network of servers that share the processing of the tasks.

### Software and Network Agents

Part of the system herein incorporates agent-based technology. This has become increasingly important for use with applications designed to interact with a subscriber for performing various computer-based tasks in foreground and background modes. Agent includes one or more computer programs that are configured to perform routine, tedious and time-consuming tasks. Agents are specialized to perform certain tasks. Thus, there exists a substantial requirement for the agent to efficiently and effectively acquire specific knowledge regarding a network or a subscriber and to utilize it to perform tasks. Some agents are software agents and reside in a computer to perform designated tasks. Some others are network agents and they move within a network, and, for example, to search for information requested by a subscriber or to execute a pre-determined process. Agents may include an object having identification information, processing procedures and data. An agent could be matched with a particular communication environment to execute the agent at a computer or a network of computers. More information on how to construct network agents may be found in U.S. Pat. No. 6,334,139, which is hereby incorporated by reference in its entirety.

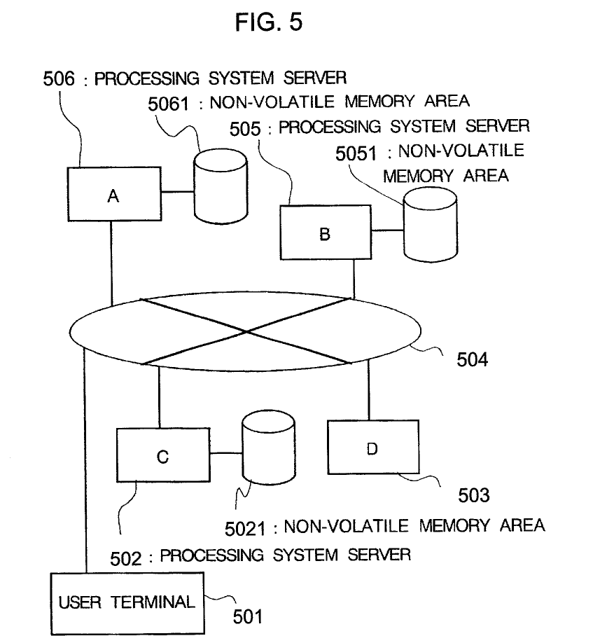

FIG. 5 is a diagram showing the configuration of agent system operation in accordance with an embodiment. An agent is executed at a processing system on a server computer. Network 504 interconnects servers having processing systems. As an example, it is the network where (IP) used in Internet passes through. An agent is created and sent from subscriber terminal 501. Processing system servers 502, 503, 505 and 506 are server systems where each processing system operates. The agent moves within the network 504 using TCP/IP (Transmission Control Protocol/Internet Protocol). This embodiment adopts, for example, UDP (User Datagram Protocol) which is one of the TCP/IP protocols. Non-volatile memory areas 5021, 5051 and 5061 are attached to the processing system servers, which are to be used by the agent being executed at the processing systems. The non-volatile memory areas 5021, 5051 and 5061 can store the agent sent to each server and can also memorize the status of agent execution. For the subscriber terminal 501, an example program that sends the agent is Java™ applet, which is programmed in Java™ programming language. The subscriber terminal may be a mobile handset with a display device that enables a subscriber to interact with the Network 504.

### Monitoring Network Conditions

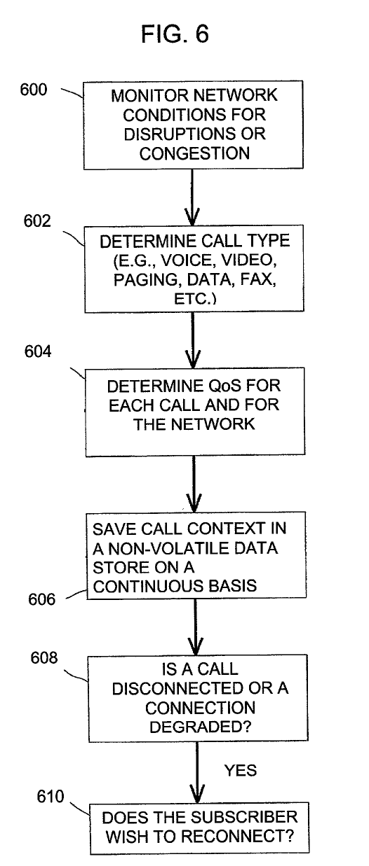

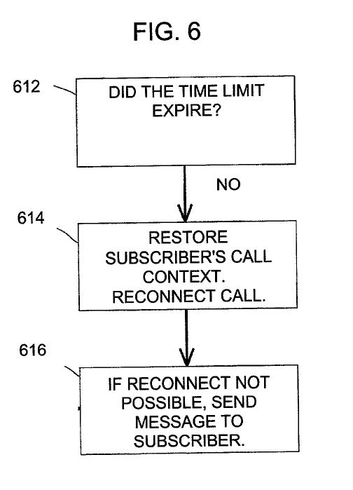

FIG. 6 is a flow chart depicting the steps performed on the server computer or other similar device coupled to the BSC or another network element.

In order to detect disruptions, potentially interfering transmissions should be monitored. Therefore, an aspect of the disclosed system includes network monitoring. To this end the server computer is suitably configured and programmed in accordance with any one of the monitoring methods known to persons of ordinary skill in the art. (Step 600). For example, U.S. Pat. No. 6,370,356 describes a method of temporarily interrupting the normal transceiver functions and providing radio communications with the mobile stations and for monitoring potentially interfering radio transmissions from the surrounding environment. That patent is hereby incorporated by reference in its entirety. Other monitoring devices include a separate monitoring antenna and accompanying monitoring circuits. Methods of monitoring network congestion include sending a periodic “keep-alive” message from one part of the network to another part and measuring the time it took to receive the message at the receiving end, measuring packet retransmissions and/or collisions in a network, measuring the Available Bit Rate (ABR) in an Asynchronous Transfer Mode (ATM) and Bit Error Rate (BER) in a packet-switched network, and other such methods. Additional methods and/or devices are described in U.S. Pat. No. 6,131,027, all of which is incorporated herein by reference in their entireties.

Further, the server computer or the BSC or the mobile terminal or both may be configured to determine the type of call. (Step 602). This could be done, for example, by using service circuit boards or similar software programs capable of performing digital signal processing and/or protocol identification within the BSC. Because a mobile terminal subscriber may be using the terminal for, among other things, voice, video, data, text (paging or E-mail), and other uses that are authorized under the 3G networking methods, it would be useful to determine the type of call in order to determine the type of bandwidth needs for that subscriber at that time.

In an embodiment, the server computer is configured to determine a quality of service QoS factor (which is a number) based on the network conditions. (Step 604). This QoS factor may indicate the type of reception at the mobile terminal at any given time. The server computer may determine a QoS factor for the entire network or it may assign a different number to each mobile terminal based on the type of activity in which the mobile terminal is engaged.

For example, though the network may be congested to deliver high quality data service to a first mobile terminal operating a video conferencing call, the network performance could be just enough to send short messaging or paging text to a second mobile terminal. Thus, the QoS factor for the first mobile terminal may show a large negative number (negative may indicate that the QoS factor is undesirable, and positive number may indicate that it is acceptable). And the QoS factor for the second mobile terminal may be positive, because the second terminal does not perceive any difficulty in receiving short messages or paging text. Similar determination could be made for other types of uses to which the mobile terminals are put. Thus, there could be a numerical score for the entire network, and a different numerical score for the particular mobile terminal, the latter depending on the type of bandwidth requirements for that terminal. Other embodiments may determine other measures of assigning numerical scores for mobile terminal activity, based on the party or device with whom the mobile terminal may be interacting.

### Reconnecting Dropped Calls

In an aspect, the instant disclosure is directed toward reconnecting dropped mobile connections for voice, data, and other media. Advantageously, a mobile terminal device may be modified and call context (i.e., information related to the call that could help reestablish a broken or lost connection) may be stored wholly or partly on the mobile terminal device and/or wholly or partly on the network side, for example, in a BSC or another device coupled to the BSC. (Step 606). This may further be accomplished by placing a “cookie” on the mobile terminal, and/or session-related information either wholly or partly stored either on the mobile terminal or on a network element such as the BSC.

It should be noted that there are two or more entities to a telephone call or even a data call. In case of a data call, the called entity may not be a natural person, or in the case of a videophone call, it could be a natural person. The server computer should determine how to react in case where there is more than one person on the telephone call. For the sake of simplicity, we describe a two-person call, a calling party and a called party. Assume further for sake of simplicity, that both persons are on mobile networks. This need not be the case, as is obvious, and in that case, the mobile subscriber may be the calling party or the called party.

Assume that there is a first party and a second party to a telephone call. Each of the two parties is connected to the communications network via telecommunication equipment, which, for the sake of simplicity and for the sake of illustration, we call switches. An analogous situation is found in the PSTN, where a calling party is connected to a central office switch and so does the called party.

### Detecting Disconnection or Degraded Connection

The server computer is programmed with a threshold QoS value for each type of connection and call. If a particular connection is below the threshold, then the connection is deemed as severely degraded for that type of call. A severely degraded connection may be reconnected after disconnection by the server computer.

When the server computer detects a disconnection on the second party's side, it attempts to reconnect, as stated above, based on the preference of the mobile subscriber. (Steps 608-610). Alternatively, when the mobile terminal reestablishes a connection with the BSC, then the BSC may decide to restore the lost connection for the mobile terminal.

But to do so, the first party should still be available for conversation. In order to ensure this, the server computer advantageously may send a signal—such as a “call hold” message—to the switch to which the first party is connected, indicating that the call has not ended despite the lack of any traffic on the line. This signal may be sent as an in-band or an out-of-band (such as ISDN or SS7 or similar) signal. In alternative embodiments, the call hold signal could be accompanied with a message indicating via a voice prompt, data, text or paging to the first party that the second party's network has temporarily become disrupted, but that an attempt was in progress to reconnect in a few seconds. Then the server computer may await instructions from the second party—a mobile communications subscriber—to attempt a reconnection. In an embodiment, the second party is thereafter billed either on a subscription basis or on a per-call basis.

All dropped calls need not be reconnected. For example, if a telemarketer is on the phone with a subscriber, the subscriber may not consider the dropped call a bad event. Thus, in an embodiment, dropped calls are reconnected only if a subscriber explicitly requests such a reconnection. Other embodiments, may, of course, reconnect a call automatically after the server computer detects a disconnection.

### Call Restoration/Reconnection

As stated above, the server computer is configured to save the context of the call. This context could be, for example a data structure similar to a call detail record or a context of a process such as a UNIX process. In the context is stored the calling party number, the called party number, IP address (the calling and called party numbers could be IP addresses if the call is a Voice-over-IP call or any other packet switched call), the type of call, and if it a data call, the amount of data successfully transmitted to the mobile terminal, any data stored in a transmit buffer, any acknowledgements received for packets that are sent to the mobile terminal, and the like.

The server computer stores the context at which the call was disconnected. This may be stored in a storage device coupled to the server, for example, in a database such as a Relational Database Management System. Thus, when the server computer then attempts to restore pre-disconnection status to the connection, it can go back to the context just prior to the disrupting event. Of course, as stated above, the reconnection may be done, in some cases, if the subscriber wishes to reconnect within a prescribed time limit. (Step 612). To accomplish this, the server computer may place a timestamp on the call context for the mobile terminal. In alternative embodiments, the call context may be written to a data in a data store on network side or on mobile terminal side or on both sides.

On the network side, call related in formation may be stored in a file, which can also identify the mobile terminal. On the mobile terminal side, the call-related information is stored in the form of a cookie or other store. Preferably the call-related information is preserved in nonvolatile memory. By thus preserving call information (context as well as other information) when the subscriber reestablishes connection with the mobile communication network within the prescribed time limit, the subscriber may be prompted to continue with his prior activity, and if he chooses so, he can be reconnected to perform the same task as before. (Step 614).

Sometimes, because the network congestion was why the call was disconnected, an immediate reconnection may not be possible. In that case, the server computer may send a message—voicemail, fax, data, video, Java applet, text, Email or other type of message—to the subscriber indicating that his call context prior to the disruption was preserved on the server and could be reestablished to continue the call at a later time. (Step 616). This is advantageous to a subscriber who was disconnected when downloading a large data file and who may not wish to waste additional download time by restarting.

### Service Level Network Assignment and Service Provisioning

Another aspect of the instant disclosure includes service-level network assignment and service provisioning. Essentially, a system administrator or a service provider allocates bandwidth to several mobile terminals based on a priority scheme. In one embodiment, the service provider uses the Priority Field for Internet Control Traffic, which is provided in the latest version of Internet Protocol specification, Internet Protocol Version 6 (Ipv6), referenced at http://playground.sun.com/pub/ipng/html/ipng-main.html.

A system administrator assigns various priority codes for several types of service areas, which could be based on traffic, congestion, atmospheric, or other conditions. The system administrator may also assign a priority code to a mobile terminal when it operates in a particular service area. Additional allocation may be based on other criteria. For example, when a mobile terminal is in a sparsely populated area with little radio interference, the mobile terminal may be allocated a larger amount of bandwidth and so it could be assigned a higher priority. Conversely, where congestion is high and/or radio interference is pronounced, then the mobile terminal may be assigned lower priority.

This allocation could also be based on type of subscriber, for example, an ambulance service or police might get higher priority whereas someone who wishes to play video games on the mobile terminal might be prioritized as a low-priority subscriber. These determinations may be also made at real-time based on a sudden increase in network congestion, or a sudden disruption of traffic as a result of, for example, a solar flare or other atmospheric event suddenly occurred and knocked some portions of the network out of service. Further allocation may be based on whether the subscriber is a premium subscriber or whether the type of data sent and received by the mobile terminal is deemed to be of low priority, for example, large chunks of video images. A service provider may determine that it would be advantageous to satisfy a larger number of subscribers that use shorter bursts of traffic rather than a single higher bandwidth.

### Queuing Incoming Wireless Data Messages

In some cases, it would be advantageous to receive and store data messages destined to a particular mobile subscriber. This is because of disruption in network connections, and other causes described elsewhere in this application. Other reasons could be that the subscriber is located at an area not served by his mobile service provider. Or, it could be a new subscriber who did not assign certain IP addresses to his newly purchased devices. In such cases, it would be advantageous to configure the server computer to receive and store broadcast messages, data pushed by an advertiser, a corporate broadcast message, and government-alert message. Suitably, the server computer maintains a queue for each subscriber for whom a message is destined. Thus, the queuing mechanism enables a guaranteed delivery of messages to a subscriber that is currently unavailable, unreachable or has turned off his mobile terminal.

When sending broadcast push information to subscribers of all kinds of devices, there is a need to make sure that the subscriber receives the message even if the device is currently unavailable, unreachable, or turned off. Similarly, when a wireless subscriber makes a request for information on a wired or wireless

In going from Ipv4 to Ipv6, there may not be enough IP address allocated to handle all subscribers at once for a network, but it can be estimated that there will only be a maximum number of subscribers using wireless Internet on a network at a particular time. Hence, a subscriber may only have an IP address allocated for a single day or for a particular time period-there is not always a one to one correspondence for a subscriber to an IP address for wireless networks based on projected use. Thus, if a wireless subscriber has not logged on and has been allocated an IP address, that subscriber still needs to receive broadcast or PUSH information. When the subscriber establishes his connection, the server computer displays a prompt message on his mobile terminal and delivers the data that is pushed and which is queued for the subscriber's use.

The foregoing describes a method and apparatus to monitor degraded or dropped calls in a mobile communication system, to restore dropped calls if needed, and to allocate network traffic to subscribers based on certain conditions. The inventive principles are described with reference to certain embodiments and to certain drawings but the invention is not limited thereto but only by the claims. Further, the disclosed system is applicable to generic cellular mobile telephone systems such as those described in the European GSM cellular mobile telephone system and other similar systems such as small capacity systems, for example, a micro-zone cellular communications system, and wherever a mobile communications system operates close to sources of radio interference or to systems which may be affected by radio communications systems described. Further, although the present invention will be described mainly with reference to mobile telephone systems it should be understood that the present invention also includes within its scope any form radio communication system, e.g. packet radio systems, public mobile radio (PMR), special mobile radio (SMR), Local Area Networks, (LAN), Metropolitan Area Networks (MAN), Wide Area Networks (WAN), paging systems and cordless telephone systems as used in private homes. The present invention is not limited to any particular access method. The following description will be made with reference to a TDMA system, namely the GSM system but the invention is not limited thereto. The present invention may also be applied to systems with other access methods, e.g. Code Division Multiple Access, CDMA. All these embodiments are therefore understood to be within the scope of the following claims.

I claim:

1. A method of restoring a disconnected mobile telephone connection, comprising the steps of:
storing a subscriber's call context on a server computer communicatively coupled to a Base Station Controller;
monitoring disruptions in the subscriber's mobile telephone connection for disconnection or degradation in the quality of the connection; and
if the subscriber's mobile telephone is disconnected or severely degraded, then reconnecting the subscriber's connection and restoring the subscriber's call context.
